(19) United States
(12) Patent Application Publication
(10) Pub. No.: US 2025/0322686 A1
(43) Pub. Date: Oct. 16, 2025

(54) GROUP SELECTION AND PARAMETERIZATION SYSTEMS AND METHODS

(71) Applicant: QSC, LLC, Costa Mesa, CA (US)

(72) Inventors: Damian Andrea Frick, Wallisellen (CH); Lorenzo Ferrini, Zurich (CH); Keivan ZAVARI, Birmensdorf (CH)

(73) Assignee: QSC, LLC, Costa Mesa, CA (US)

(21) Appl. No.: 19/177,149

(22) Filed: Apr. 11, 2025

Related U.S. Application Data
(60) Provisional application No. 63/633,413, filed on Apr. 12, 2024.

(51) Int. Cl. G06V 40/10; G06T 7/70; G06V 20/52

(52) U.S. Cl. CPC G06V 40/103; G06T 7/70; G06V 20/52; G06T 2207/30196

(57) ABSTRACT

A computer system may execute a computer-implemented method that includes extracting visual identifiers from within a field of view of a camera. The method includes determining, based on the extracted visual identifiers, one or more prominent participants within the field of view. The method further includes generating, based on the extracted visual identifiers and the one or more prominent participants, a group selection that prioritizes the one or more prominent participants. The method further includes parameterizing the group selection such that the group selection dynamically adjusts to include the prominent participants within the field of view of the camera. The method further includes tracking, via a camera, the parameterized group selection.

### PRIORITY

This non-provisional application claims priority to U.S. Provisional Application No. 63/633,413, filed on Apr. 12, 2024, the disclosure of which is hereby incorporated by reference in its entirety.

### TECHNICAL FIELD

The present technology is generally directed to selecting and parameterizing targets within an external environment of a visual sensor, and more specifically to system and methods for dynamic selection and parameterization of objects within an external environment via at least one visual sensor.

### SUMMARY

Technical aspects of the present disclosure are generally directed to a system and method of accurately selecting and grouping prominent individuals from within the field of view of a camera based on certain visual information. Further, technical aspects of the system and method include parameterizing the grouping of prominent individuals, based on the visual information, such that the parameterization allows for static framing adjustment or seamless, dynamic tracking of the prominent individuals as they change their initial positions within an environment.

The system and method, in accordance with technical aspects of the present disclosure, may extract visual identifiers from within a field of view of a camera. Technical aspects may further determine, based on the extracted visual identifiers, one or more prominent participants within the field of view. Technical aspects may further generate, based on the extracted visual identifiers and the one or more prominent participants, a group selection that prioritizes the one or more prominent participants. Technical aspects may further parameterize the group selection such that the group selection dynamically adjusts to include the prominent participants within the field of view of the camera. Technical aspects may further include track, via a camera, the parameterized group selection.

The system and method, in accordance with technical aspects of the present disclosure, may extract at least one of visual, audial, and spatial information from an external environment. Technical aspects may further fuse the extracted information into a three-dimensional, external-environment map. Technical aspects may further reconstruct, based on the fused information, visual identifiers within a field of view a camera. Technical aspects may further generate, within the field of view of the camera, a group selection that prioritizes the one or more prominent participants. Technical aspects may further parameterize the group selection such that the group selection dynamically adjusts to include the prominent participants within the field of view of the camera. Technical aspects may further track, via the camera, the parameterized group selection.

The system and method, in accordance with technical aspects of the present disclosure, may transform captured sensor data into a camera image-plane based on camera pose. Technical aspects may further generate visual information from the captured sensor data using a predefined basis of at least one participant. Technical aspects may further determine, based on the extracted visual information, one or more prominent participants within a field of view of a camera. Technical aspects may further generate, based on the extracted visual information and the one or more prominent participants, a group selection that prioritizes at least one of the one or more prominent participants. Technical aspects may further parameterize the group selection such that the group selection dynamically adjusts to include the prominent participants within the field of view of the camera. Technical aspects may further track, via a camera, the parameterized group selection.

The system and method, in accordance with technical aspects of the present disclosure, may extract visual identifiers from an external environment within a field of view of a first camera. Technical aspects may further determine, based on the extracted visual identifiers, one or more prominent participants within the field of view. Technical aspects may further generate a group selection that prioritizes one or more prominent participants. Technical aspects may further parameterize the group selection such that the group selection dynamically adjusts to include the prominent participants within the field of view of the camera. Technical aspects may further track, via a second camera, the parameterized group selection.

These and other features which characterize various embodiments of the present disclosure can be understood in view of the following detailed discussion and the accompanying drawings.

### BRIEF DESCRIPTION OF THE DRAWINGS

FIG. 1 illustrates an example environment in which various technical aspects of the present disclosure can be practiced, in accordance with some embodiments of the present disclosure.

FIG. 2A is an exemplary representation illustrating how technical aspects of the present disclosure may be implemented, in accordance with some embodiments of the present disclosure.

FIG. 2B is an exemplary representation illustrating how technical aspects of the present disclosure may select prominent individuals from within the field of view of a camera lens, in accordance with some embodiments of the present disclosure.

FIG. 2C is an exemplary representation illustrating how technical aspects of the present disclosure may parameterize a group selection of the prominent participants of FIG. 2B, in accordance with some embodiments of the present disclosure.

FIG. 3 is a flowchart illustrating a method for implementing various technical aspects of the present disclosure, in accordance with some embodiments of the present disclosure.

FIG. 4 is a system diagram illustrating technical aspects of the present disclosure, in accordance with some embodiments of the present disclosure.

FIG. 5 is a flowchart illustrating a method for implementing various technical aspects of the present disclosure, in accordance with some embodiments of the present disclosure.

FIG. 6 is a flowchart illustrating a method for implementing various technical aspects of the present disclosure, in accordance with some embodiments of the present disclosure.

FIG. 7 is a flowchart illustrating a method for implementing various technical aspects of the present disclosure, in accordance with some embodiments of the present disclosure.

FIG. 8 is a schematic diagram of a processor circuit, in accordance with some embodiments of the present disclosure.

### DETAILED DESCRIPTION

Videoconferencing systems play a pivotal role in facilitating communication and collaboration. Whether for business meetings, remote work, or personal interactions, videoconferencing platforms enable real-time conversations across geographical boundaries. These tools allow participants to see and hear each other, share screens, and collaborate on documents. With features like chat, breakout rooms, and virtual backgrounds, videoconferencing has become an integral part of our daily lives, bridging gaps and fostering connections in an increasingly digital landscape. One example of videoconferencing system is an audio, video, and control (AVC) system, for example, that is included in the Seervision and Q-SYS technologies from QSC, LLC.

A videoconferencing system can be configured to manage and control functionality of audio features, video features, and control features of one or more peripheral devices. For example, a videoconferencing system can be configured for use with one or more peripheral devices, including microphones, cameras, amplifiers, processing cores, displays, controllers (e.g., touch-screen controllers), and sensors (e.g., human presence detectors, time-of-flight sensors, etc.). At times, the terms “peripheral device” and “sensor” may be used interchangeably throughout the present disclosure. The videoconferencing system can also include a plurality of related features for processing audio, video, and other sensor data, captured by the peripheral devices and/or sensors, such as acoustic echo cancellation, audio tone control and filtering, audio dynamic range control, audio/video mixing and routing, audio/video delay synchronization, Public Address paging, video object detection, verification and recognition, multi-media player and a streamer functionality, user control interfaces, scheduling, third-party control, voice-over-IP (VoIP) and Session Initiated Protocol (SIP) functionality, scripting platform functionality, audio and video bridging, public address functionality, fusion of audio data, video data, and sensor data, other audio and/or video output functionality, etc.

One problem inherent in videoconferencing systems is maintaining one or more prominent participants within a camera field of view as one or more prominent participants change their position. For example, a prominent participant may change their position in a way that is outside of the field of view of a camera. Or, if the camera dynamically tracks one of the prominent participants, the remaining prominent participants are no longer within the field of view of the camera. Another problem inherent in the field of videoconferencing systems is establishing and maintaining a desired location and size of one or more prominent participant within a camera field of view from some initial field of view.

Accordingly, there is a long-felt need in the technical field of videoconferencing for a system and method of dynamically identifying a group comprising one or more prominent participants to establish a desired location and size of frame of one or more participants within a camera field of view from an initial field of view. Further, there is a long-felt need to track within a field of view of a camera and parameterize, via a group selection, their spatial location relative to a camera field of view such that they stay within the field of view irrespective of their movements.

Technical aspects of the present disclosure include a system and computer-implemented method that comprises extracting visual information from within a field of view of a camera; determining, based on the extracted visual information, one or more prominent participants within the field of view; generating, based on the extracted visual information and the one or more prominent participants, a group selection that prioritizes the one or more prominent participants; parameterizing the group selection such that the group selection dynamically adjusts to include the prominent participants within and/or at the desired location and size within the field of view of the camera; and framing or tracking, via a camera, the parameterized group selection.

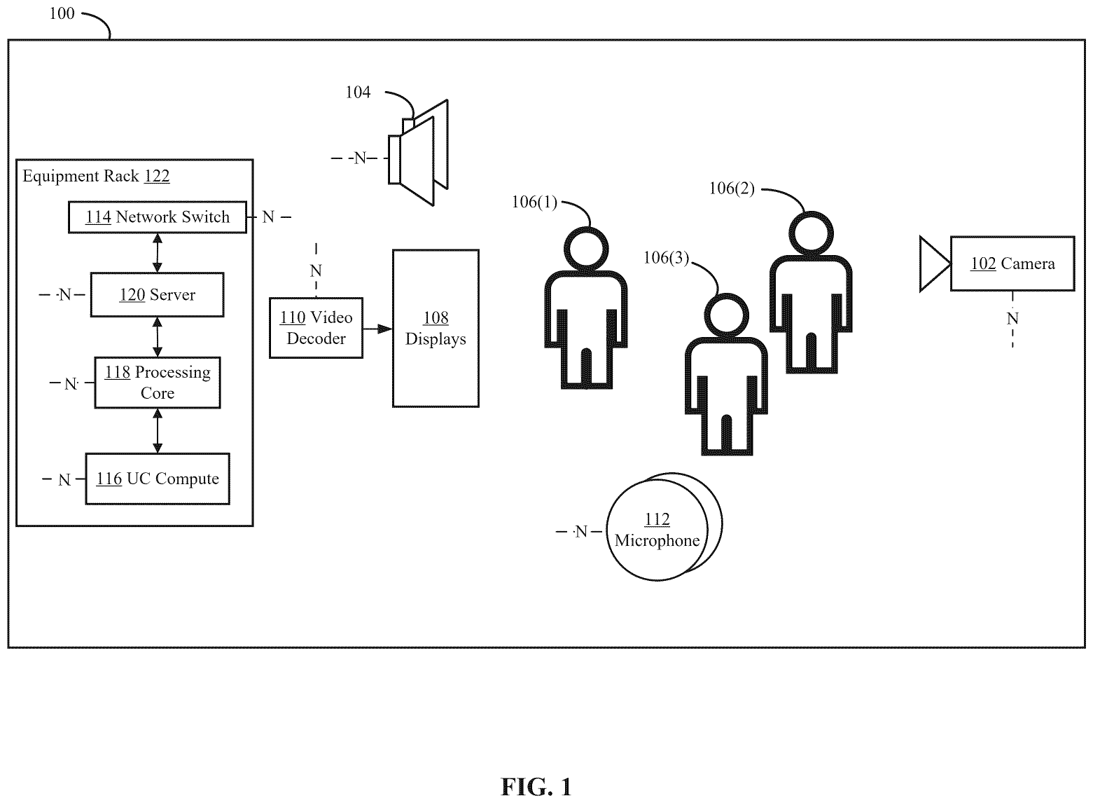

Several implementations are discussed below in more detail in reference to the Figures. FIG. 1 is a block diagram illustrating an overview of devices on which some implementations of the disclosed technology can operate. In the example shown in FIG. 1, a videoconferencing room 100 includes one or more camera(s) 102, speaker(s) 104, video display(s) 108, video encoder 110, microphone(s) 112, touch screen controllers (not shown), a network switch 114, amplifier (not shown), UC Compute 116, a processing core 118, a server 120 (e.g., an Al accelerator), and a network (e.g., Ethernet), N, that facilitates communication between one or more of the aforementioned electronic devices. In some embodiments, some or all of the aforementioned devices do not communicate over a network, but rather one or more other media of communication.

Camera(s) 102 may capture video data and microphone(s) 112 may capture audio data within videoconferencing room 100 that includes one or more participants 106(1)-(3) therein. Camera(s) 102 may be oriented in such a position as to have each of one or more participants 106 within a field of view. Network camera 102 may then transmit the captured video data, via network N, to server 120, where server 120 extracts visual information from within the field of view of network camera. The extracted visual information includes individual detections of participants via bounding boxes or masks. In addition, technical aspects of the present disclosure detect one or more key features that indicate relevant landmarks on each participant's body such as the location of eyes, nose, shoulder, hips, etc.

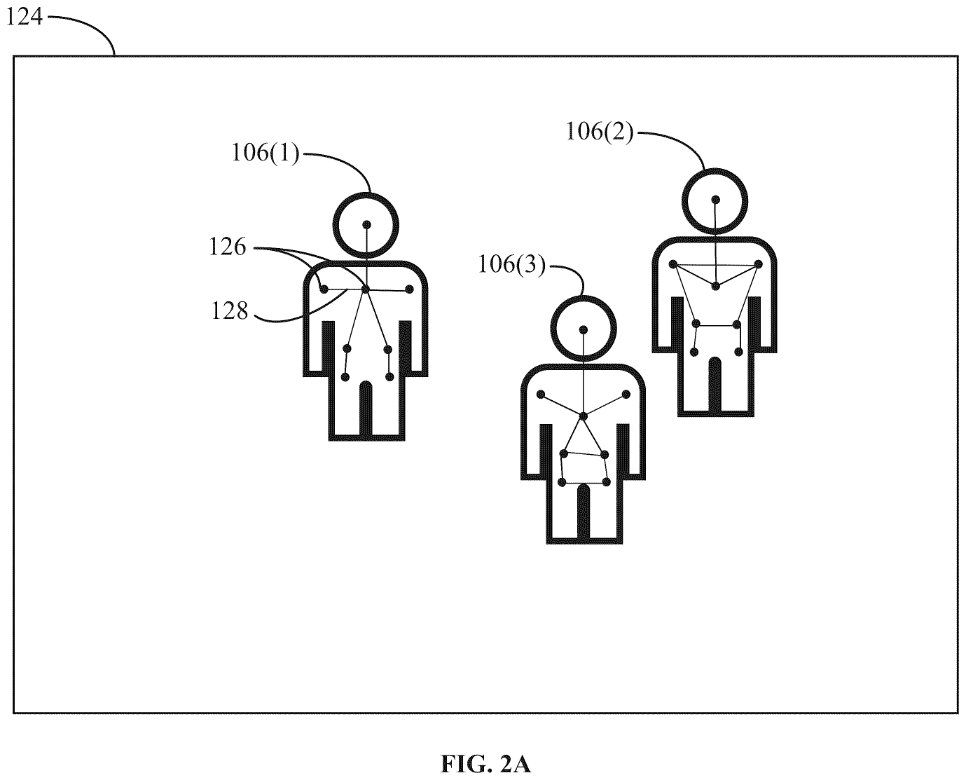

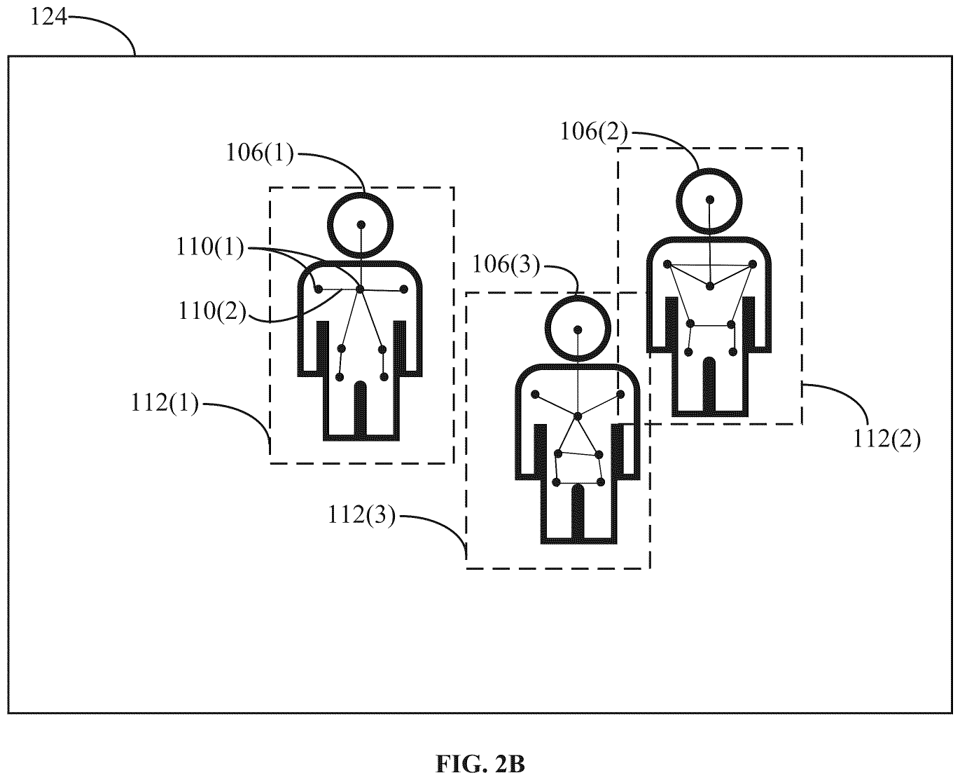

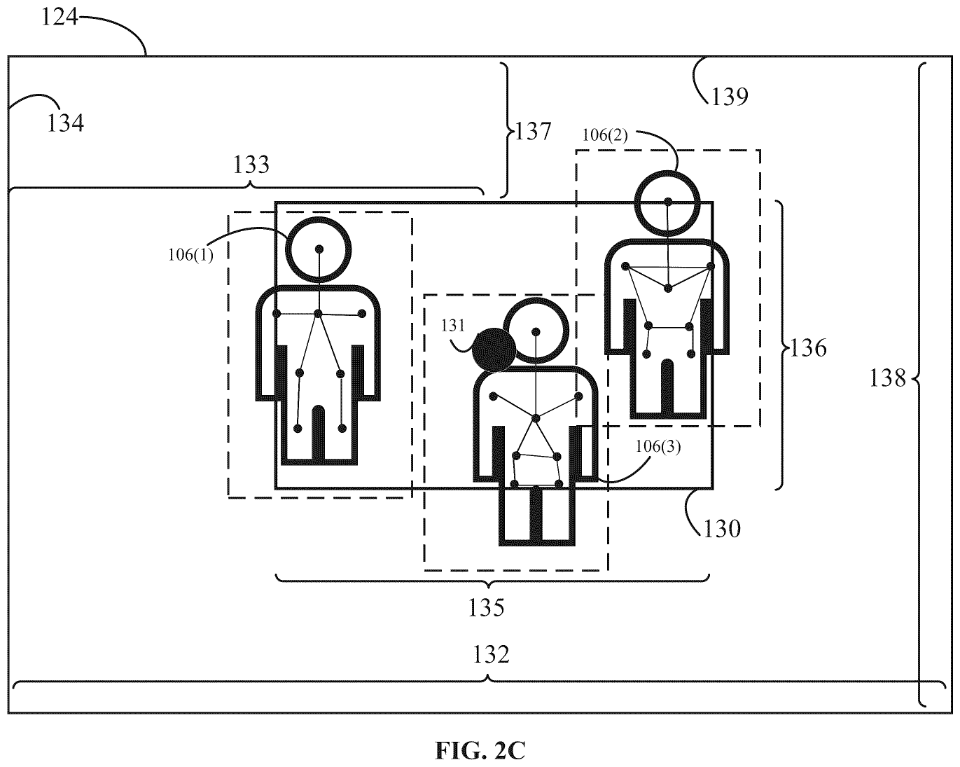

The process of extracting visual information may involve the identification of participants through the use of bounding boxes or masks, either of which may serve to delineate the outer limits of each participant within a frame of the video data. In addition to this detection mechanism, technical aspects of the present disclosure may be equipped with the capability to recognize and pinpoint a series of key features (e.g., key features 126, with reference to FIGS. 2A and 2B), that may include points or landmarks on the body of each participant. These key features aide in understanding the posture, orientation, and movement of the participants and include, but are not limited to, the locations of anatomical and facial landmarks such as the eyes, nose, shoulders, joints, elbows, wrists, hips, knees, and ankles.

The identification of these key features may be achieved through sophisticated image processing and pattern-recognition algorithms, either of which may include neural networks and/or deep-learning algorithms. The image processing and pattern-recognition algorithms analyze the extracted visual information to detect variations in shape, color, and texture that correspond to the above key features. This advanced level of detection and analysis allows for a deeper understanding of the visual scene, enabling applications that require precise participant tracking and behavior analysis.

From this visual information, server 120 determines which of the one or more participants are prominent participants. Prominent participants may be determined based on their size, location and/or orientation, as well as other relevant visual features. In one embodiment, the largest participants (e.g., large relative to other participants in a background) are selected as the most prominent. In another embodiment, the participants are clustered according to location (e.g., distance from each other participant) and size and the most prominent cluster is selected based on its location and size.

In embodiments, prominent participants may be selected using a multifaceted analysis based on several factors. These factors may include, but are not limited to, the size, location, and orientation of the participants, along with other visual characteristics that may influence their prominence within a frame of video data. In embodiments, prominence of a participant may be quantitatively assessed by selecting the participants who occupy the largest areas within a frame, relative to other participants within the frame, thereby designating any number of the largest participants as the most prominent figures in the scene. In embodiments, the largest participants may not be determined relative to other participants but rather than satisfy a participant-size threshold, for example, the participant occupies more than a predetermined number of pixels within the frame.

Alternatively, in embodiments, the system employs a clustering algorithm (e.g., as commonly known in the arts) to group participants based on their spatial proximity and comparative sizes. Within this framework, clusters of participants are evaluated, and the cluster deemed most prominent is selected according to its collective size and the strategic positioning of the participants within the frame of video data. This allows for a dynamic assessment of prominence, accommodating scenarios where the significance of a participant or group of participants is dictated by their spatial relationships and aggregate visual impact, rather than solely by individual size or location metrics.

Once the prominent participants are determined, server 120 may generate a group selection that prioritizes prominent participants. The group selection 130 in FIG. 2C is created based on a set of default, user-defined or dynamic settings that determine the desired location and size of the group in the camera frame.

Further, server 120 can parameterize the group selection such that if any of one or more participants alters their initial position to a second position, camera 102 (or camera 103) adjusts any one of an actuator, including pan, tilt, or zoom setting, so that the one or more prominent participants stays within the field of view of camera 102 according to the parameterization and the camera's position and field of view is adjusted to achieve the desired location and size of the group in the frame. For example, as discussed below with reference to FIGS. 2C through FIG. 7, parameterization may be a default, user-defined, or dynamic setting that defines a distance between parameters of a group selection and/or parameters of the field of view of camera 102. So, as group-selection parameters adjust to dynamically capture movement of the prominent participant(s) within the field of view, the ratio of the group selection parameters is consistent with the field-of-view parameters.

Before continuing, it should be noted that the examples described above are provided for purposes of illustration and are not intended to be limiting. Other devices and/or device configurations may be utilized to carry out the operations described herein.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block and may thus represent an improvement in the user interface over existing art by providing information not otherwise available.

Similarly, block diagrams may show a particular arrangement of components, modules, services, steps, blocks, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

FIG. 2A is a block diagram illustrating an overview of extracting visual information of one or more participants 106 within a field of view 124 of camera 102 (or camera 103). Camera 102 transmits captured video data to server 120 or processing core 118 for processing of the captured video data. Once the video data is processed, several key features 126 (e.g., the key features as discussed above, including points or landmarks on the body of each participant) of participants 106 are recognized and one or more links 128 connecting one or more of the key features 126 are generated; one or more links 128 may be optional. In embodiments, in addition to, or rather than, recognizing several key features 126, a bounding box may be generated for every participant 106 that overlays at least a portion of each participant 106.

FIG. 2B is a block diagram illustrating an overview illustrating the determination of one or more prominent participants 112(1)-(3) (as represented by bounding boxes) of the one or more participants 106 within field of view 124 of camera 102 based on the identified key features 126 of participants 106. In embodiments, after determining key features 126 from extracted visual information, server 120 may specify a number of prominent participants and generate corresponding identifications 112(1)-112(3) for every participant belonging to a group. Identification of the prominent participants is substantially similar to the methods described above with reference to FIG. 1. Identifications 112 may include a participant 106 unique identifier, a participant's 106 position, and so on.

FIG. 2C is a block diagram illustrating an overview of defining a group selection 130 of participants 106; group selection 130 may include a center 131. In embodiments, server 120 may define the group selection 130 horizontal and/or vertical sizes as a function of the distance of the most “distant” body key feature 110 (e.g., a key identifier, that is the head of participant 106(2), may be the top of the vertical component of group selection 130) in a frame of captured video data belonging to the group.

Further, in embodiments, once group selection 130 is generated, group selection 130 may be parameterized. Parameterization may define a distance or ratio (e.g., constant or variable) between any location of group selection 130, including a perimeter of group selection, center 131 of group selection 130, and so on, and a perimeter of field of view 124. Parameterization of group selection 130 may have one or more outcomes: maintaining prominent participants within field of view 124 of camera 120 as well as maintaining a desired location and size of each prominent participant within field of view 124.

In some embodiments, parameterization may include specifying a list of all prominent participants 106 that require framing. Parameterization may include defining a group horizontal size 135 as a distance of the most distant body key features in the frame of video data belonging to prominent participants within group selection 130. For example, group horizontal size 135 may extend from a left-most key feature 110 of prominent participant 106(1) to a right-most key feature 110 of prominent participant 106(2). Likewise, with a vertical size 136 of group selection 130 extending from a highest key feature 110 of any participant 106 to a lowest key feature 110 of any prominent participant.

A relative size parameter may be defined as a ratio between group horizontal size 135 and the horizontal width 132 of the frame of video data. A maximum value of the ratio may be the numerical value, 1, because further zooming of camera 102 would alter the definition of group selection 130 by, for example, losing key features 110 and/or prominent participants 106. Further, there may be x and y-components, where x-component may be defined as a distance 133 between group center 131 and a first side 134 of field-of-view 124.

Further, y-component may be defined as the vertical position of the highest key feature 110 (e.g., the center of head of prominent participant 106(2)) of any prominent participant 106 within group selection 130, and may extend to a second side 139 of field of view 124. For example, y-component may be defined as a distance 137. The x and y-components may be any value, ranging from 0 to 1, and to any significant digit, including 0.25, 0.7, 0.9999, 1, etc. It can take values in the range from zero to one, but the actual framing may be constrained so not to lose any participant of the group. For example, a framing of zero will align the left extreme of the group with the left of the frame not the center of the group.

Other examples of parameterization are contemplated within the scope of the present disclosure. In embodiments, y-component may be a vertical side 138 of field of view 124. In some examples, the x and y-components may be defined in any manner, for example, they may be set distances, for example, from any group-selection perimeter to any field-of-view perimeter, any key feature 110 to another key feature 110, from a key feature 110 to any field-of-view perimeter, the x and y-components may be set distances with group center 131 as an origin, and so on. Any combination of the above distances or other distances, and/or ratios thereof, between perimeters or any location within field of view are within the contemplation of the present disclosure.

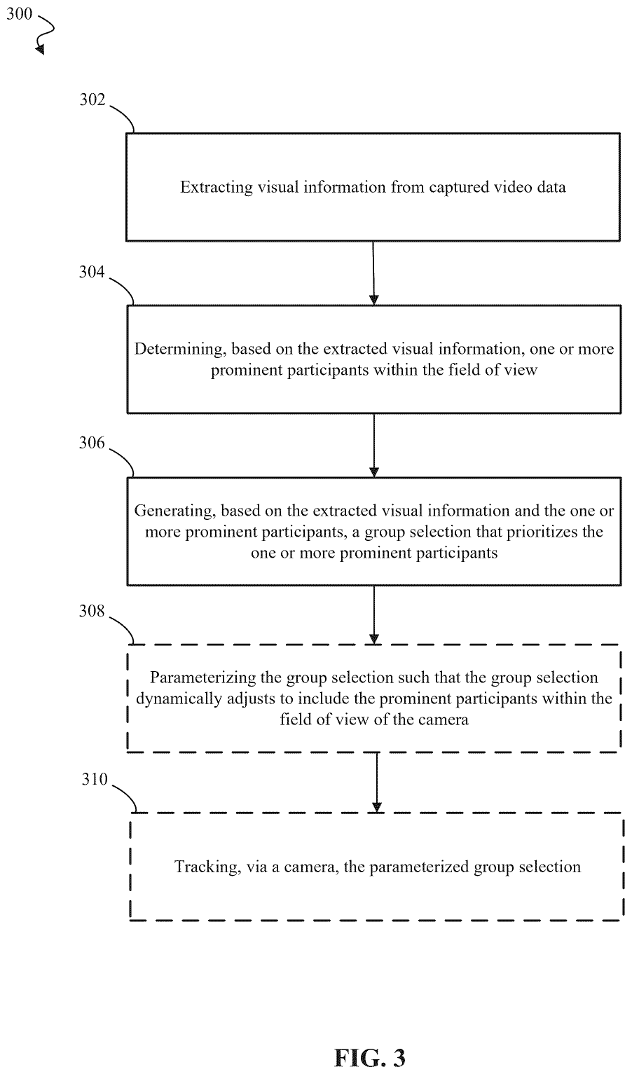

FIG. 3 is a flowchart illustrating a method 300 for retaining prominent participants 106 within a field of view 108 of a camera 102 as they move from their initial position throughout, for example, a videoconferencing room 100. Method 300 includes extracting visual information from video data. Method 300 further includes determining one or more prominent participants within the field of view. Method 300 further includes generating a group selection that prioritizes one or more prominent participants. Method 300 optionally includes parameterizing the group selection such that the group selection dynamically adjusts to include the prominent participants within the field of view. Method 300 optionally includes tracking the parameterized group selection as the prominent participants alter their positions.

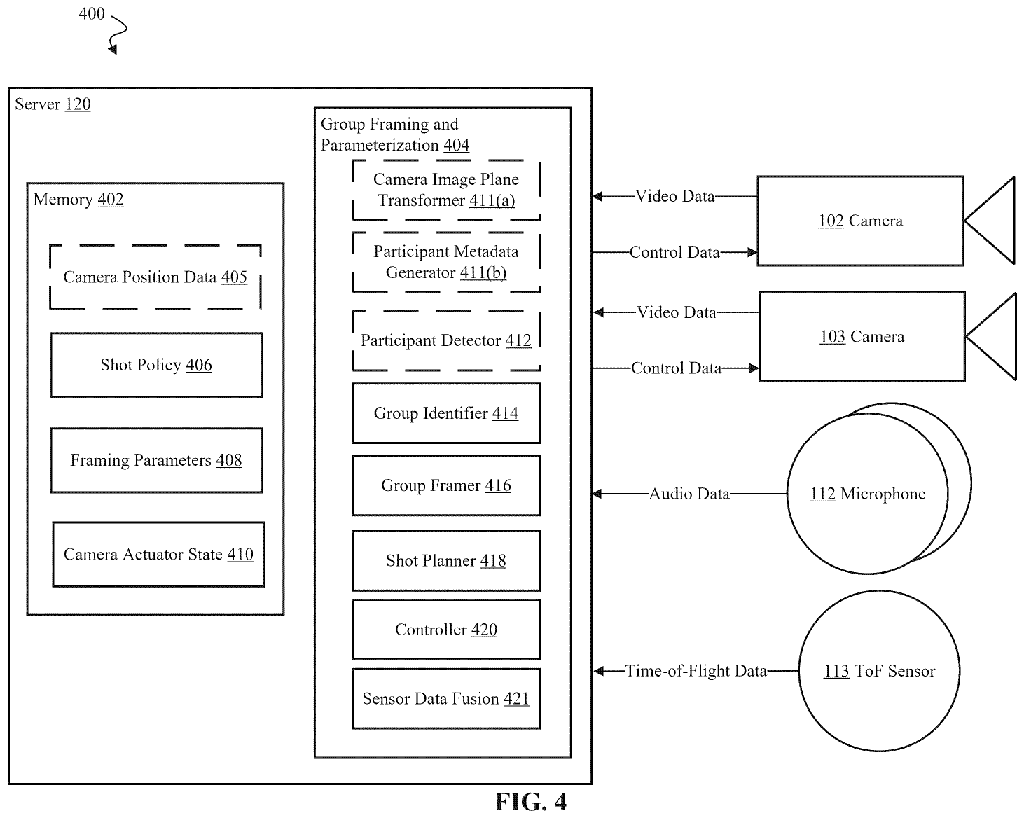

FIG. 4 is a system 400 diagram for implementing technical aspects of the present disclosure, according to an embodiment. System 400 includes camera 102 and/or camera 103 providing server 120 with captured video data from an external environment to camera 102 and/or camera 103. In examples, the captured video data is transmitted from camera 102 and/or camera 103 to server 120 over network, for example, as discussed with reference to FIG. 1. System 400 may further include additional sensors, including, but not limited to, microphone 112 and time-of-flight sensor 113, providing server 120 sensor data, including, but not limited to, audio data and time-of-flight data.

Server 120 may include a memory 402 and group framing and parameterization 404. Memory 402 may include a camera position data 405, shot policy 406, framing parameters 408, and a camera actuator state 410. Group framing and parameterization 404 may include a camera image plane transformer 411(a), participant metadata generator 411(b), participant detector 412, a group identifier 414, a group framer 416, a shot planner 418, a controller 420, and sensor data fusion 421. Server 120 may include more or fewer modules/components.

Upon server receiving video data from camera 102, participant detector 412 may extract and process visual information from the captured video data to detect each of the participants (e.g., participants 106) within one or more frames of video data. Further, participant detector 412 may generate image metadata from the extracted and processed visual information; such metadata may include bounding boxes, key features, and so on, as described above, with reference to at least FIG. 1.

Alternatively, rather than, or in addition to, participant detector 412 processing video data to detect participants, technical aspects of the present disclosure may process audio data captured by microphone 112, time-of-flight data captured by ToF sensor 113, and other sensor data captured by sensors not shown in FIG. 4. In addition to capturing audio data, microphone 112 may determine a source of arrival or a location of the speaker, and transmit location data (e.g., participant location data) of the audio source (e.g., participant) to server 120. Alternatively, microphone 112 may provide server 120 with audio data; server 120 processes the audio data to determine a source of arrival or a location of the speaker. In addition, ToF sensor 113 may capture time-of-flight data from the external environment and provide the time-of-flight data to server 120. Server 120 may complement the audio data with time-of-flight data to determine the location of the talker more accurately.

In embodiments, optionally, microphone 112 may transmit audio data and location data captured from within conference room 100 to server 120. Camera image plane transformer 411(a) may receive the captured audio data and location data and, further, call camera position data 405 from memory 402. Camera image plane transformer 411(a) may process the audio data, location data, and camera position data 405 to transform the audio data to a camera image plane. The camera image plane may be transmitted to participant metadata generator 411(b), where participant metadata generator 411(b) generates participant metadata, for example, using a predefined basis participant that may be superimposed on the camera-image plane, thereby forming a digital representation of the conference room 100 and the relative position of participants 106 within conference room 100 using audio data, rather than solely using video data.

Participant detector 412 may transmit the processed visual information, including image metadata, or participant metadata generator 411(b) may transmit the generated participant metadata, to group identifier 414 for identification of a group that includes one or more participants 106. Using either the generated participant metadata from participant metadata generator 411(b) or the processed visual information from participant detector 412, group identifier may identify a group that includes one or more participants 106. In doing so, group identifier 414 may call shot policy 406. The shot policy 406 determines which method of determining prominent participants (see above) is used in case multiple methods are implemented and may include a user-defined list of identifications of participants (IDs): a user-defined list of people that comprise a group that may be framed; the number of people and positions: a user-defined list of the number of participants within a group and an approximate position of each participant within a frame of the captured video data; and, a list of every participant within a frame of the captured video data.

Group identifier 414 may group the participants within a frame of the captured video data according to shot policy 406. For example, group identifier 414 may identify a group of the participants within a frame of the captured video data according to the user-defined list of IDs; the number of participants and position and size of each participant; given the position passed through a clustering algorithm (e.g., the clustering algorithm that groups participants based on their spatial proximity and comparative sizes, as discussed with reference to FIG. 1) is started that groups participants with similar size and position in frame; and all the participants currently within the frame.

Group identifier 414 may provide the identified group to group framer 416. Group framer 416 may parameterize the group, for example, according to the position of in the frame, the current size in the frame, the number of participants, and/or as discussed with reference to FIG. 2C.

Shot planner 418 may call either or both of framing parameters 408 and current actuator state 410 from memory 402. Framing parameters 408 may include a position of group selection 130 including center 131, x-component, and y-component, as discussed with reference to FIGS. 2A-2C. Further, framing parameters 408 may include the relative size of the frame of captured video data, that includes a zoom setting of camera 102 (or camera 103), for example, when the frame was captured by camera 102 or the current state of camera 102. Camera actuator state may include the state of actuator of camera 102, for example, the settings and configuration of the actuator that manipulates lens of camera 102 to secure focus and stability for when camera 102 captures video data. Camera actuator state may further include the settings and configuration of the orientation of camera 102, including pan, tilt, and zoom. Shot planner 418 may analyze either or both of framing parameters 408 and camera actuator state 410 to predict a trajectory of the group selection 130 so that the actuator of camera 102 can dynamically capture group selection 130 within, and relative to, field of view 108 according to framing parameters 408 such that the prominent participants 106 stay within the field of view and the relative size and location of any of them are at a relative distance from the perimeter of the field of view.

Controller 420 may receive the planned trajectory of group selection 130 from shot planner 418 and send settings and configurations (e.g., pan, tilt, zoom, velocity commands, crop x, y, and z velocities of frame, etc.) in the form of control data to network camera 102 or camera 103 that, when camera 102 or camera 103 repositions itself according to the settings and configurations, camera 102 or camera 103 captures group selection 130 respective to field of view 108 according to framing parameters 408.

In embodiments, sensor data fusion 421 may fuse sensor data (e.g., video data, audio data, time-of-flight data, and so on) received by server 120. For example, processed audio data (e.g., to determine a direction of arrival, timestamp of noises, etc.) may be fused with video data (e.g., identification of participants or objects for confirmation of who is talking) and time-of-flight data (e.g., to determine more accurately that the direction of arrival of captured speech coincides with time-of-flight data that identified an individual). Sensor data fusion 421 may construct a global coordinate system, that is a virtual representation of the physical environment, for example, that includes each object and their relative spatial relation to each other.

In embodiments, the planned trajectory may be static or dynamic. For example, camera 120 may establish a desired framing of group selection 130 and maintain the desired frame, thereby maintaining camera 102 or camera 103 in a static position and orientation. In addition, when any of the prominent participants move from an initial position such that group selection 130 adjusts, camera 102 or camera 103 may track the desired framing so that the relative size and location of the grouped prominent participants are maintained.

Technical aspects of the present disclosure further contemplate any number (e.g., 1, 2, 3, . . . , n, when n is any real number) of sensors/peripheral devices (such as cameras, microphones, ToF sensors, thermal sensors, human presence sensors, etc.), servers, and so on, as part of, or communicably coupled with, system 400. For example, any of the sensors/peripheral devices, servers, etc. may be located within a same room, different rooms, different locations (e.g., server or sensors/peripheral devices may be located remotely, such as within a cloud computing environment), and any combination thereof. In embodiments, the above process may begin by camera 102 capturing video data, server 120 processing the captured video data, and then server 120 may provide the above instructions for camera 103 to select the group and parameterize accordingly.

Technical aspects of the present disclosure further contemplate a first camera (e.g., camera 102) of a plurality of cameras (e.g., camera 103 as well as other cameras not shown FIG. 4) that may capture video data and transmit the video data to server 120. Server 120 may extract the visual information, as discussed throughout; determine one or more prominent participants within the video data; generate a group selection that prioritizes one or more participants; parameterize the group selection; and transmit instructs for such to a second camera of the plurality of cameras (e.g., camera 103).

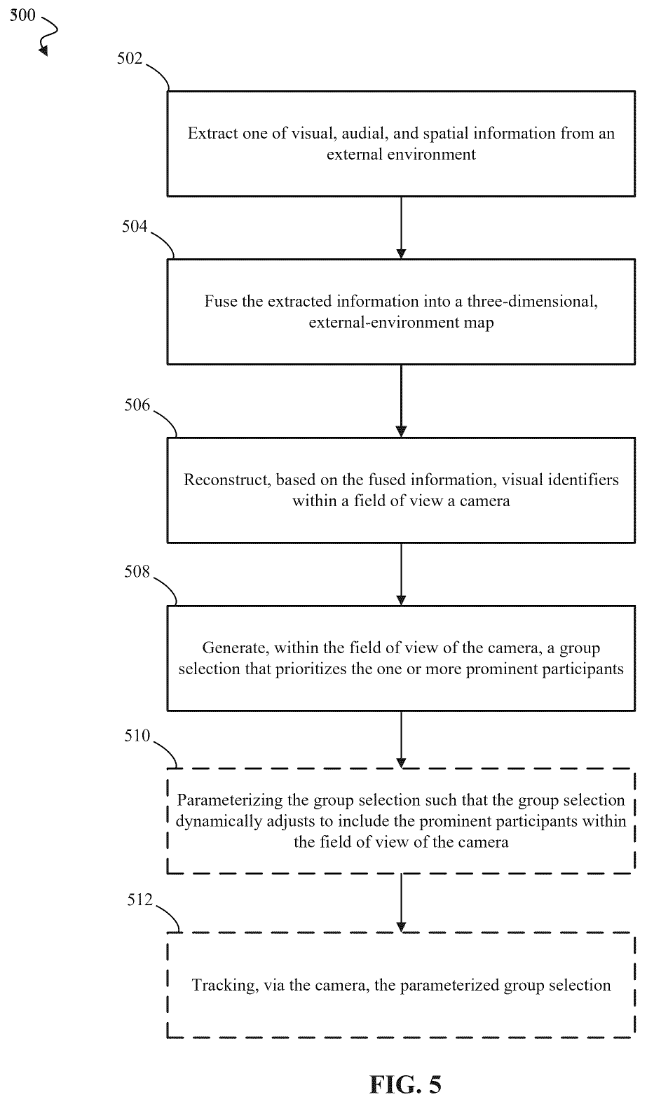

FIG. 5 is a flowchart illustrating a method 500 for retaining prominent participants 106 within a field of view 108 of a camera 102 as they move from their initial position throughout, for example, a videoconferencing room 100. Method 500 includes extracting (502) one of visual, audial, and spatial information from an external environment. Method 500 further includes fusing (504) the extracted information into a three-dimensional (e.g., global coordinate system, as discussed above), external-environment map. Method 500 further includes reconstructing (506), based on the fused information, visual identifiers within a field of view a cameras. Method 500 further includes generating (508), within the field of view of the camera, a group selection that prioritizes the one or more prominent participants. Method 500 optionally includes parameterizing (510) the group selection such that the group selection dynamically adjusts to include the prominent participants within the field of view of the camera. Method 500 optionally includes tracking (512) the parameterized group selection as the prominent participants alter their positions.

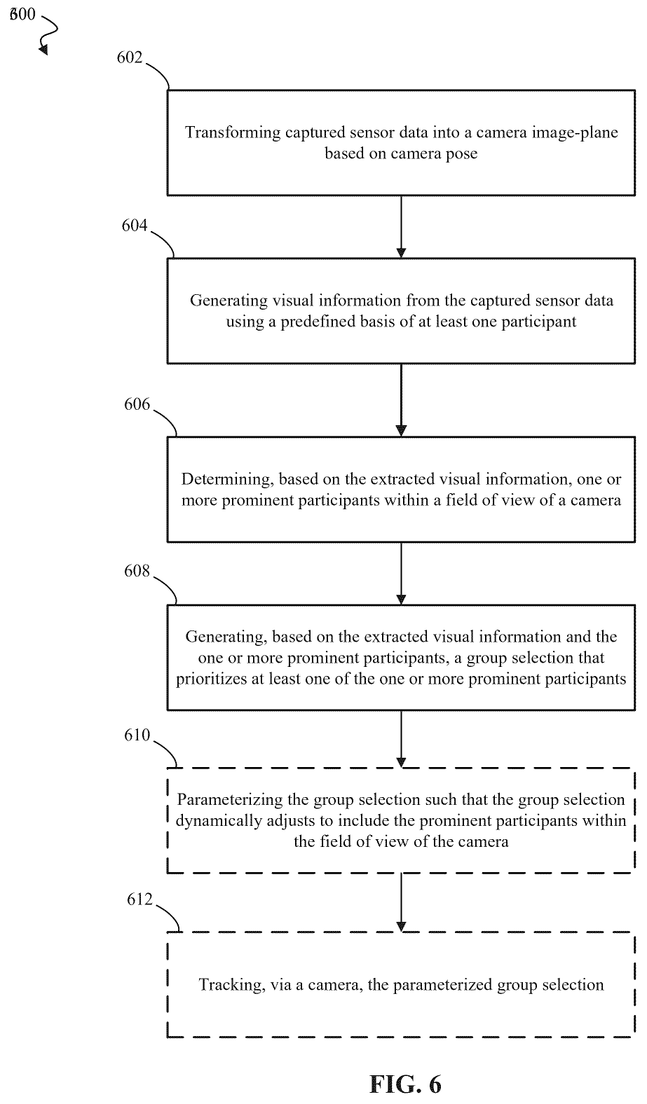

FIG. 6 is a flowchart illustrating a method 600 for implementing technical aspects of the present disclosure. Method 600 includes transforming (602) captured sensor data into a camera image-plane based on a camera pose. In one example of block 602, as discussed above, the sensor data may include at least one of captured video data, audio data, wideband data camera image plane transformer 411(a) may process the audio data, time-of-flight sensor data, video data, camera position data, and other sensor data to transform at least the audio data to a camera image plane.

Method 600 further includes generating (604) visual information from the captured sensor data using a predefined basis of at least one participant. Method 600 further includes determining (606) one or more prominent participants within the field of view of a camera. Method 600 further includes generating (608) a group selection that prioritizes at least one of the one or more participants. Method 600 further includes parameterizing (610) the group selection such that the group selection dynamically adjusts to include the prominent participants within the field of view of the camera. Method 600 further includes (612) tracking, via the camera, the parameterized group selection.

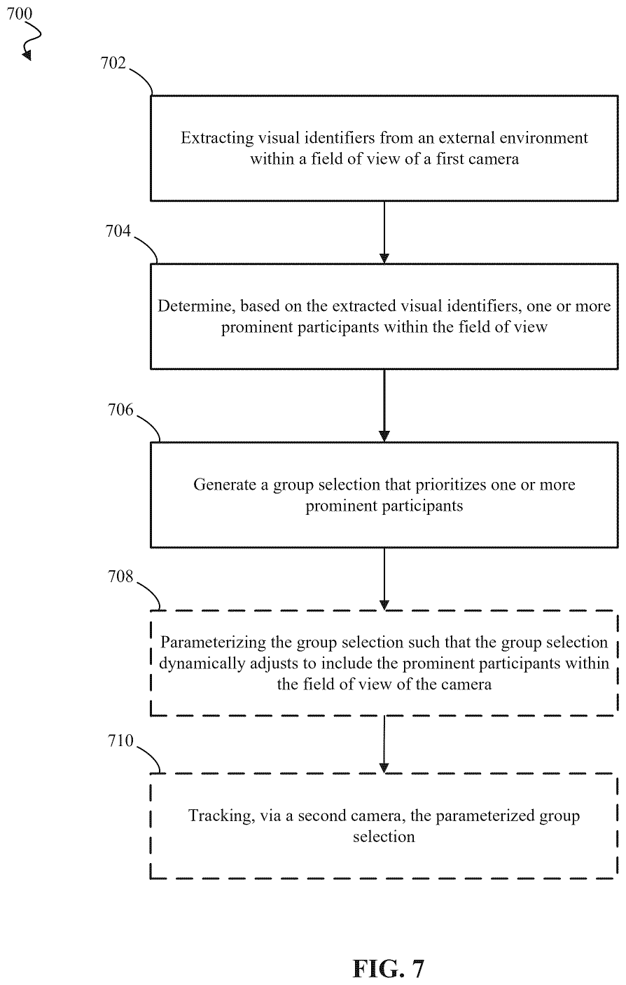

FIG. 7 is a flowchart illustrating a method 700 for implementing technical aspects of the present disclosure. Method 700 includes extracting (702) visual identifiers from an external environment within a field of view of a first camera (e.g., camera 102). Method 700 further includes (704) determining (704), based on the extracted visual identifiers, one or more prominent participants within the field of view. Method 700 includes generating (706) a group selection that prioritizes one or more prominent participants. Method 700 includes parameterizing (708) the group selection such that the group selection dynamically adjusts to include the prominent participants within the field of view of the camera. Method 700 includes tracking (710), via a second camera (e.g., camera 103), the parameterized group selection.

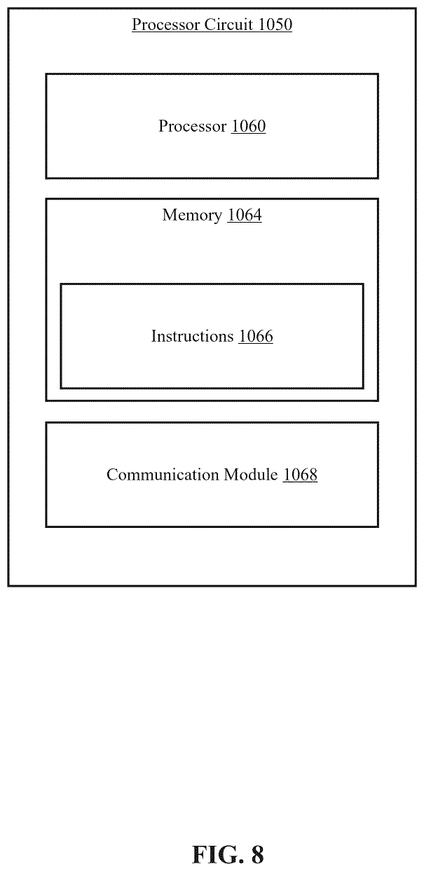

FIG. 8 is a schematic diagram of a processor circuit 1050, according to embodiments of the present disclosure. The processor circuit 1050 may be implemented in the UC compute 116, a personal computer, a touchscreen controller, processing core 118, network switch 114, server 120, or other devices or workstations (e.g., third-party workstations, network encoders/decoders, etc.), or on a cloud processor or other remote processing unit, as necessary to implement the method. As shown, processor circuit 1050 may include a processor 1060, a memory 1064, and a communication module 1068. These elements may be in direct or indirect communication with each other, for example via one or more buses.

The processor 1060 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1060 may also comprise another hardware device, a firmware device, or any combination thereof configured to perform the operations described herein. The processor 1060 may also be implemented as a combination of computing devices, e.g., a combination of a DSP and a microprocessor, a plurality of microprocessors, one or more microprocessors in conjunction with a DSP core, or any other such configuration.

The memory 1064 may include a cache memory (e.g., a cache memory of the processor 1060), random access memory (RAM), magneto resistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, memory 1064 includes a non-transitory computer-readable medium. Memory 1064 may store instructions 1066. Instructions 1066 may include instructions that, when executed by processor 1060, cause processor 1060 to perform the operations described herein. Instructions 1066 may also be referred to as code. The terms “instructions” and “code” should be interpreted broadly to include any type of computer-readable statement(s). example, the terms “instructions” and “code” may refer to one or more programs, routines, sub-routines, functions, procedures, etc. “Instructions” and “code” may include a single computer-readable statement or many computer-readable statements.

The communication module 1068 can include any electronic circuitry and/or logic circuitry to facilitate direct or indirect communication of data between the processor circuit 1050, and other processors or devices. In that regard, the communication module 1068 can be an input/output (I/O) device. In some instances, the communication module 1068 facilitates direct or indirect communication between various elements of the processor circuit 1050 and/or the videoconferencing rooms 100 and other videoconferencing rooms (not shown). The communication module 1068 may communicate within processor circuit 1050 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial, and parallel communications may be bridged by a Universal Asynchronous Receiver Transmitter (UART), Universal Synchronous Receiver Transmitter (USART), or another appropriate subsystem.

External communication (including but not limited to communication over the wide area network) may be accomplished using any suitable wireless or wired communication technology, such as a cable interface such as a universal serial bus (USB), Ethernet, micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. Information may also be transferred on physical media such as a USB flash drive or memory stick.

A number of variations are possible on the examples and embodiments described above. For example, the technology described herein can be applied to multiple videoconferencing rooms at once, whether in the same building or across multiple buildings, and can also be applied to more complex audiovisual systems, including soundstages, amphitheaters, recording studios, etc.

The technology described herein may be applied to UC computers, processing cores, servers, etc. of various types, including but not limited to servers, desktop computers, laptop and notebook computers, tablets, or smartphones, and virtual computers running operating systems such as Windows, MacOS, Linux, IOS, Android, etc.

Accordingly, the logical operations making up the embodiments of the technology described herein are referred to variously as operations, steps, blocks, objects, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the virtualized hardware bridging system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the virtualized hardware bridging system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

Methods and embodiments described herein further relate to any one or more of the following paragraphs:

A. A computer-implemented method, comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and tracking, via a camera, the parameterized group selection.

B. A computer-implemented method, comprising:
extracting one of visual, audial, and spatial information from an external environment;
fusing the extracted information into a three-dimensional, external-environment map;
reconstructing, based on the fused information, visual identifiers within a field of view a camera;
generating, within the field of view of the camera, a group selection that prioritizes the one or more prominent participants;
parameterizing the group selection such that the group selection dynamically adjusts to include the prominent participants within the field of view of the camera; and
tracking, via the camera, the parameterized group selection.

C. A computer-implemented method, comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.

D. A computer-implemented method, comprising:
extracting visual identifiers from an external environment within a field of view of a first camera;
determining, based on the extracted visual identifiers, one or more prominent participants within the field of view;
generating a group selection that prioritizes one or more prominent participants;
parameterizing the group selection such that the group selection dynamically adjusts to include the prominent participants within the field of view of the camera; and
tracking, via a second camera, the parameterized group selection.

E. A computer-readable storage medium storing instructions that, when executed by a computing system, cause the computing system to perform operations comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and
tracking, via a camera, the parameterized group selection.

F. A computer-readable storage medium storing instructions that, when executed by a computing system, cause the computing system to perform operations comprising:
extracting one of visual, audial, and spatial information from an external environment;
fusing the extracted information into a three-dimensional, external-environment map;
reconstructing, based on the fused information, visual identifiers within a field of view a camera;
generating, within the field of view of the camera, a group selection that prioritizes the one or more prominent participants;
parameterizing the group selection such that the group selection dynamically adjusts to include the prominent participants within the field of view of the camera; and
tracking, via the camera, the parameterized group selection.

G. A computer-readable storage medium storing instructions that, when executed by a computing system, cause the computing system to perform operations comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.

H. A computer-readable storage medium storing instructions that, when executed by a computing system, cause the computing system to perform operations comprising:
extracting visual identifiers from an external environment within a field of view of a first camera;
determining, based on the extracted visual identifiers, one or more prominent participants within the field of view;
generating a group selection that prioritizes one or more prominent participants;
parameterizing the group selection such that the group selection dynamically adjusts to include the prominent participants within the field of view of the camera; and
tracking, via a second camera, the parameterized group selection.

I. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and
tracking, via a camera, the parameterized group selection.

J. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
extracting one of visual, audial, and spatial information from an external environment;
fusing the extracted information into a three-dimensional, external-environment map;
reconstructing, based on the fused information, visual identifiers within a field of view a camera;
generating, within the field of view of the camera, a group selection that prioritizes the one or more prominent participants;
parameterizing the group selection such that the group selection dynamically adjusts to include the prominent participants within the field of view of the camera; and
tracking, via the camera, the parameterized group selection.

K. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.

L. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
extracting visual identifiers from an external environment within a field of view of a first camera;
determining, based on the extracted visual identifiers, one or more prominent participants within the field of view;
generating a group selection that prioritizes one or more prominent participants;
parameterizing the group selection such that the group selection dynamically adjusts to include the prominent participants within the field of view of the camera; and
tracking, via a second camera, the parameterized group selection.

What is claimed is:

1. A computer-implemented method, comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and
tracking, via a camera, the parameterized group selection.

2. A computer-implemented method, comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.

3. A computer-readable storage medium storing instructions that, when executed by a computing system, cause the computing system to perform operations comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and
tracking, via a camera, the parameterized group selection.

4. A computer-readable storage medium storing instructions that, when executed by a computing system, cause the computing system to perform operations comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.

5. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
extracting visual identifiers from within a field of view of a camera;
determining, based on the extracted visual identifiers, one or more prominent participants within the field of view;
generating, based on the extracted visual identifiers and the one or more prominent participants, a group selection that prioritizes the one or more prominent participants;
parameterizing the group selection such that the group selection dynamically adjusts to include the prominent participants within the field of view of the camera; and
tracking, via a camera, the parameterized group selection.

6. A system, comprising: one or more peripheral devices; and a processing core communicably coupled to the peripheral devices, the processing core having an operating system executable thereon to manage and control functionality of the peripheral devices, wherein the operating system is adapted to perform operations comprising:
transforming captured sensor data into a camera image-plane based on camera pose;
generating visual information from the captured sensor data using a predefined basis of at least one participant;
determining, based on the extracted visual information, one or more prominent participants within a field of view of a camera;
generating, based on the extracted visual information and the one or more prominent participants, a group selection that prioritizes at least one of the one or more prominent participants;
parameterizing the group selection such that the group selection dynamically adjusts to include the prominent participants within the field of view of the camera; and
tracking, via a camera, the parameterized group selection.
